(19) United States
(12) Patent Application Publication
(10) Pub. No.: US 2023/0300787 A1
(43) Pub. Date: Sep. 21, 2023

(54) UE OFFSET TO AVOID PAGING COLLISION FOR MULTI-USIM DEVICES

(71) Applicant: Telefonaktiebolaget LM Ericsson (publ), Stockholm (SE)

(72) Inventors: Mai-Anh PHAN, HERZOGENRATH (DE); Christofer LINDHEIMER, VADSTENA (SE); Alessio TERZANI, STOCKHOLM (SE); Qian CHEN, MÖLNDAL (SE); Paul SCHLIWA-BERTLING, LJUNGSBRO (SE)

(21) Appl. No.: 18/015,817

(22) PCT Filed: Aug. 3, 2021
(86) PCT No.: PCT/IB2021/057095

§ 371 Date: Jan. 12, 2023

Related U.S. Application Data
(60) Provisional application No. 63/062,058, filed on Aug. 6, 2020.

(51) Int. Cl. H04W 68/00

(52) U.S. Cl. CPC H04W 68/005; H04W 84/042

(57) ABSTRACT

A method performed by a multi-universal subscriber identity module, multi-USIM user equipment, UE, operating in a first public land mobile network, PLMN, and another PLMN, and a multi-USIM UE is provided. The method includes responsive to at least one of receiving an updated 5G-global unique temporary identifier or changing a cell in which the multi-USIM UE is operating, determining whether or not there is a paging occasion (PO) collision with the other PLMN. The method includes responsive to determining that there is a PO collision: notifying a core network about the PO collision; receiving a configuration from the core network, the configuration having a UE_offset value; using the UE_offset value for PO calculation and monitoring; and determining whether or not there is a PO collision with the other PLMN using the UE_offset value.

### TECHNICAL FIELD

The present disclosure relates generally to wireless communications, and more particularly to communication methods and related devices and nodes to avoid paging collision when a UE with more than one SIM-card is registered to more than one network at the same time.

### BACKGROUND

3GPP started a study for supporting multiple USIM (universal subscriber identity module) in one device for Rel-17 from October 2019.

A multi-USIM (multi-GSM (global system for mobile communications) universal subscriber identity module) device can hold more than one set of USIM credentials and access more than one network at the same time. The USIM can be a physical SIM-card that a user can insert, or the USIM can also be eSIM credentials and identity that is stored in a memory in a device.

A multi-USIM UE can thus access, for example, two different networks PLMN1 (public land mobile network 1) and PLMN2 (public land mobile network 2) using identity and credentials from USIM1 and USIM2 respectively. Dependent on UE type, there are aspects related to how much a UE can do “simultaneously” towards the two networks. For example, if a UE only has one TX processing unit / chain implemented, it would only be capable of transmitting to a single network at a time. Similarly, if a UE only had one Rx processing unit /chain implemented, it would only be capable of receiving transmissions from a single network at the time. This means, such UE will miss any message sent by PLMN2 if it is listening for messages in PLMN1.

### SUMMARY

A multi-USIM UE with a single Rx processing unit /chain can receive transmissions from one PLMN at the time. One major issue is the possibility to miss the Paging message sent by a PLMN, if the UE listening to the Paging in the other PLMN, causing performance degradation in terms of paging detection.

This may happen if the Paging Occasions (PO) for the different USIMs are overlapping in time domain. This may also happen when non-overlapping paging occasions are very close in time, and the multi-USIM UE may miss a page from a PLMN due to retuning delays.

According to some embodiments of inventive concepts, a method performed by a multi-universal subscriber identity module, multi-USIM user equipment, UE, operating in a first public land mobile network, PLMN, and another PLMN is provided. The method includes responsive to at least one of receiving an updated 5G-global unique temporary identifier or changing a cell in which the multi-USIM UE is operating, determining whether or not there is a paging occasion (PO) collision with the other PLMN. The method includes responsive to determining that there is a PO collision: notifying a core network about the PO collision; receiving a configuration from the core network, the configuration having a UE_offset value; using the UE_ offset value for PO calculation and monitoring; and determining whether or not there is a PO collision with the other PLMN using the UE_offset value.

A multi-USIM UE, computer program, and computer program product having analogous operations are provided.

The various embodiments of inventive concepts provide an approach to avoid paging collision when the PO for the different USIMs are overlapping.

According to some other embodiments of inventive concepts, a method performed by a core network node is provided. The method includes receiving ) a paging occasion, PO, collision indication from a multi-subscriber identity module, multi-USIM, user equipment, UE. The method includes generating a UE_offset. The method includes transmitting the UE_ offset to the multi-USIM UE.

A core network node, computer program, and computer program product having analogous operations are provided

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is diagram illustrating an example of paging collisions;

FIG. 2 is a diagram illustrating an example of a UE_offset to avoid paging collisions according to some embodiments of inventive concepts;

FIG. 3 is a signaling diagram illustrating communications between components of a network according to some embodiments of inventive concepts;

FIG. 4 is a signaling diagram illustrating communications between a core network node and a radio access network node according to some embodiments of inventive concepts;

FIG. 5 is a signaling diagram illustrating a core network paging procedure according to some embodiments of inventive concepts;

FIG. 6 is a signaling diagram illustrating a RAN paging procedure according to some embodiments of inventive concepts;

FIG. 7 is a flow chart illustrating operations of a multi-USIM UE according to some embodiments of inventive concepts.

FIG. 8 is a block diagram illustrating a multi-USIM UE according to some embodiments of inventive concepts;

FIG. 9 is a block diagram illustrating a radio access network RAN node (e.g., a base station eNB/gNB) according to some embodiments of inventive concepts;

FIG. 10 is a block diagram illustrating a core network CN node (e.g., an AMF node, an SMF node, etc.) according to some embodiments of inventive concepts; and

FIG. 11 is a flow chart illustrating operations of a core network node according to some embodiments of inventive concepts;

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

FIG. 8 is a block diagram illustrating elements of a multi-USIM UE 200 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. As shown, multi-USIM UE may include an antenna 807, and transceiver circuitry 801 (also referred to as a transceiver) including a transmitter and a receiver configured to provide uplink and downlink radio communications with a base station(s) of a radio access network. Multi-USIM UE may also include processing circuitry 803 (also referred to as a processor) coupled to the transceiver circuitry, and memory circuitry 805 (also referred to as memory, e.g., corresponding to a device readable medium) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that separate memory circuitry is not required. Multi-USIM UE 200 may also include an interface (such as a user interface) coupled with processing circuitry 803, and/or Multi-USIM UE may be incorporated in a vehicle.

As discussed herein, operations of multi-USIM UE may be performed by processing circuitry 803 and/or transceiver circuitry 801. For example, processing circuitry 803 may control transceiver circuitry 801 to transmit communications through transceiver circuitry 801 over a radio interface to a radio access network node (also referred to as a base station) and/or to receive communications through transceiver circuitry 801 from a RAN node over a radio interface. Moreover, modules may be stored in memory circuitry 805, and these modules may provide instructions so that when instructions of a module are executed by processing circuitry 803, processing circuitry 803 performs respective operations (e.g., operations discussed below with respect to Example Embodiments relating to Multi-USIM UEs). According to some embodiments, a multi-USIM UE 200 and/or an element(s)/function(s) thereof may be embodied as a virtual node/nodes and/or a virtual machine/machines.

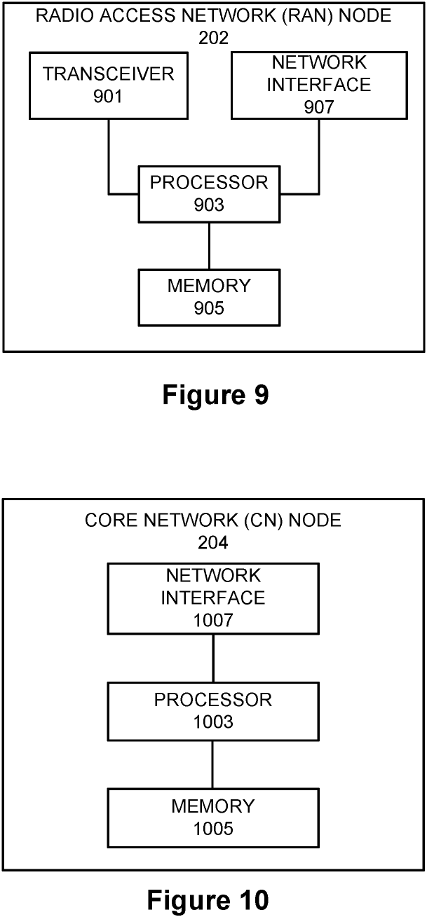

FIG. 9 is a block diagram illustrating elements of a radio access network RAN node 202 (also referred to as a network node, base station, eNodeB/eNB, gNodeB/gNB, etc.) of a Radio Access Network (RAN) configured to provide cellular communication according to embodiments of inventive concepts. As shown, the RAN node may include transceiver circuitry 901 (also referred to as a transceiver) including a transmitter and a receiver configured to provide uplink and downlink radio communications with mobile terminals. The RAN node may include network interface circuitry 907 (also referred to as a network interface) configured to provide communications with other nodes (e.g., with other base stations) of the RAN and/or core network CN. The network node may also include processing circuitry 903 (also referred to as a processor) coupled to the transceiver circuitry, and memory circuitry 905 (also referred to as memory, e.g., corresponding to a device readable medium) coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that a separate memory circuitry is not required.

As discussed herein, operations of the RAN node may be performed by processing circuitry 903, network interface 907, and/or transceiver 901. For example, processing circuitry 903 may control transceiver 901 to transmit downlink communications through transceiver 901 over a radio interface to one or more mobile terminals UEs and/or to receive uplink communications through transceiver 901 from one or more mobile terminals UEs over a radio interface. Similarly, processing circuitry 903 may control network interface 907 to transmit communications through network interface 907 to one or more other network nodes and/or to receive communications through network interface from one or more other network nodes. Moreover, modules may be stored in memory 905, and these modules may provide instructions so that when instructions of a module are executed by processing circuitry 903, processing circuitry 903 performs respective operations (e.g., operations discussed below with respect to Example Embodiments relating to RAN nodes). According to some embodiments, RAN node 202 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE such as the multi-USIM UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 10 is a block diagram illustrating elements of a core network CN node (e.g., an SMF node, an AMF node, etc.) of a communication network configured to provide cellular communication according to embodiments of inventive concepts. As shown, the CN node may include network interface circuitry 1007 (also referred to as a network interface) configured to provide communications with other nodes of the core network and/or the radio access network RAN. The CN node may also include a processing circuitry 1003 (also referred to as a processor) coupled to the network interface circuitry, and memory circuitry 1005 (also referred to as memory) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the CN node 204 may be performed by processing circuitry 1003 and/or network interface circuitry 1007. For example, processing circuitry 1003 may control network interface circuitry 1007 to transmit communications through network interface circuitry 1007 to one or more other network nodes and/or to receive communications through network interface circuitry from one or more other network nodes. Moreover, modules may be stored in memory 1005, and these modules may provide instructions so that when instructions of a module are executed by processing circuitry 1003, processing circuitry 1003 performs respective operations (e.g., operations discussed below with respect to Example Embodiments relating to core network nodes). According to some embodiments, CN node 204 and/or an element(s)/function(s) thereof may be embodied as a virtual node/nodes and/or a virtual machine/machines.

As previously indicated, a multi-USIM UE with a single Rx processing unit /chain can receive transmissions from one PLMN at the time. One major issue is the possibility to miss the Paging message sent by a PLMN, if the UE listening to the Paging in the other PLMN, causing performance degradation in terms of paging detection.

This may happen if the Paging Occasions (PO) for the different USIMs are overlapping in time domain. The UE may also need time for tuning to the other PLMN such that non-overlapping paging occasions that are very close in time may also be missed by the UE. This can lead to paging failure and waste of unnecessary system resources.

According to 3GPP TS 36.304 and 3GPP TS 38.304 the following are the formulas for calculating Paging Frame (PF) and Paging Occasions (POs):
(System Frame Number) SFN for the PF is determined by:
$$5 \text{G:} \left(\text{SFN} + \text{PF\_offset}\right) mod \text{T} = \left(\text{T} \text{div} \text{N}\right) \text{*} \left(\text{UE\_ID} mod \text{N}\right)$$
$$\text{LTE:} \text{SFN} \text{mod} \text{T=} \left(\text{T} \text{div} \text{N}\right) \text{*} \left(\text{UE\_ID} mod \text{N}\right)$$
Index (i_s), indicating the index of the PO is determined by:
i_s = floor (UE_ID/N) mod Ns Where:

| | |
|---|---|
| UE_ID: 5G-S-TMSI mod 1024 | (in the 5GS) |
| UE_ID: IMSI mod 1024 | (in the EPS) |

Due to the mod 1024 operation in the UE_IDthe POs are determined only by the last 10 bits of the IMSI (EPS) or the 5G-S-TMSI (5GS).

Assuming for simplicity that the two PLMNs are synchronized at SFN (system frame number) level, whenever the last 10 bits of the UE_ID in the PLMNs are the same, the PO of the two PLMN will be the same. This causes the Paging collision, meaning that a single Rx UE listening for Paging in one PLMN might miss the Paging sent in the other PLMN, since it is sent at the same PO.

Even though the two systems are not synchronized at SFN level, there can be combinations of UE_ID that will lead to overlap of the POs, which can cause performance degradation in terms of paging detection.

In EPS (evolved packet system), the POs are calculated based on a permanent subscription identifier (e.g., international mobile subscribed identity (IMSI)), which means that if the IMSIs associated with the two USIM cards are matching in the last 10 bits, the paging collisions will be systematic.

The POs in 5GS are calculated based on the 5G-S-TMSI (5G Shortened Temporary Mobile Subscriber Identity) which can be reassigned over time at the Mobility Registration procedure. The frequency of 5G-S-TMSI reassignment is left to the operator. Due to the 5G-S-TMSI reassignment in one system or the other system, the possibility for paging collisions can occur at any time. The 5G-S-TMSI is the shortened form of the 5G-GUTI to enable more efficient radio signalling procedures (e.g. paging and Service Request), see 3GPP TS 23.003, Section 2.9. The descriptions below sometimes refer to re-assignment of the 5G-GUTI by the CN, which implies a modification of the 5G-S-TMSI. As specified in TS 23.003: <5G-GUTI> = <MCC><MNC> <AMF Region ID> <AMF Set ID><AMF Pointer> <5G-TMSI> and <5G-S-TMSI> = <AMF Set ID><AMF Pointer><5G-TMSI>, such that <5G-GUTI> = <MCC><MNC> <AMF Region ID> <5G-S-TMSI>

It should be noted that the PF/PO also depend on other parameters configurable on cell level (e.g. T, N, Ns). This means that even though the UE_ID does not change, there is the possibility of PO collision when the UE performs a cell change in each of the PLMNs.

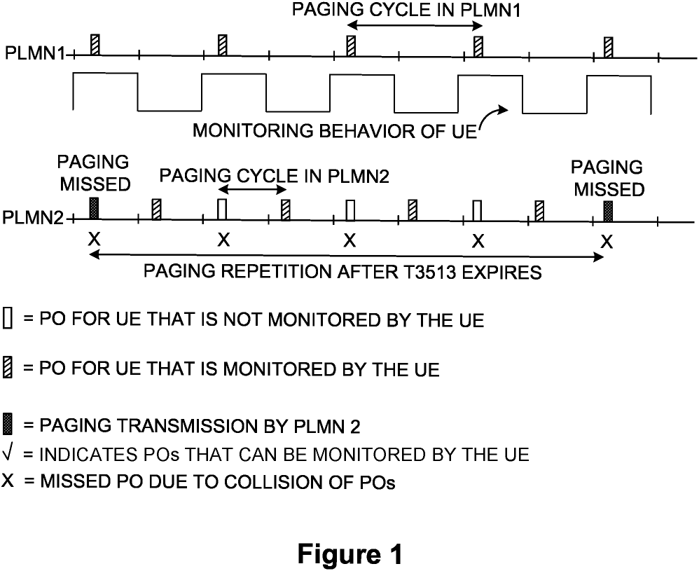

FIG. 1 shows an example of Paging collision: the slots in hatching indicates where the multi-USIM UE is listening for the Paging message (PLMN1 or PLMN2). Clear slots are paging occasions for the multi-USIM UE that are not monitored by the UE. An “X” indicates where a missed paging occasion occurs due to collision of paging occasions. If the UE is listening to PLMN1 while the Paging message is sent by PLMN2, the message is missed (solid filled-in slot). It is noted that the monitoring behavior of the UE is for illustration purposes. It is up to UE implementation of when and how long to switch between PLMN1 and PLMN2 to monitor the POs of PLMN1 and PLMN2 respectively.

For EPS, 3GPP TR 23.761-040, Solution 16 describes a method to add a MUSIM offset to the IMSI to derive the UE_ID

Previous solutions using the possibility to change the 5G-S-TMSI (provided by the 5GC) are only applicable when Multi-USIM UE is registered to at least one 5GC network. When a Multi-USIM UE is registered to two EPC networks, the paging collision issue cannot be resolved because the IMSI in LTE/EPC cannot be changed.

Various embodiments of inventive concepts shall now be described that avoid paging collision when the PO for the different USIMs are overlapping. The embodiments address a situation when a UE is in CM-IDLE/RRC-IDLE, or possibly when a UE is in CM-CONNECTED/RRC-INACTIVE state in both PLMNs

Several embodiments are based on the idea to the 5G-S-TMSI (provided by the 5GC), so it is applicable to a Multi-USIM UE registered to two 5GC networks, or to EPC and 5GC networks. These embodiments are not applicable in case the Multi-SIM UE is registered to two EPC networks because once the IMSI is assigned, it cannot be changed.

The embodiments address the paging collision for both CN (core network) Paging (UE in RRC-IDLE) and RAN (radio access network) Paging (UE in RRC-INACTIVE) and the nodes are configured to use the same PO calculation including a UE_offset for both CN Paging and RAN Paging.

The UE_offset is either added to the UE_IDin the PO formula or alternatively modifies the UE_ID.

The UE calculates PF and PO and checks for PO collision with the other PLMN. If the collision is detected, the UE notifies the CN (e.g., the access and mobility management function (AMF)/mobility management entity (MME) and requests a UE_offset. In some embodiments, the notification can be the Multi-USIM UE initiating a Mobility Registration Update or TAU request from one of the Multi-USIM UE’s PLMN (public land mobility network) indicating a need to allocate a UE offset.

The CN (AMF/MME) generates a UE_offset. Based on the knowledge of used IMSIs and 5G-S-TMSIs, the CN can select a UE_offset to equally distribute the UEs in the configured paging occasions.

The CN configures the UE with the UE_offset and also provides the UE_offset to the RAN (gNB/eNB) as part of the UE context. Thus the CN (AMF/MME) allocates a UE offset value to the multi-USIM UE in the Registration or TAU Accept message sent back to the multi-USIM UE. The CN (AMF/MME) can provide the allocated UE offset as part of CN assistance information for RRC Inactive if the CN is in a 5GS.

During the IDLE mode paging, the CN (AMF/MME) shall provide the UE offset (e.g. as part of the Assistance data for Paging) to the RAN in the Paging Request message and the RAN shall use the UE offset and the UE identity index value to calculate the PF/PO. If the Multi-USIM UE is in RRC inactive in 5GS, the RAN may also use the UE offset and UE identity index value to calculate the PR/PO.

This procedure is repeated whenever the UE detects a Paging collision. The UE checks for paging collisions whenever the UE is configured with a new 5G-GUTI or upon cell change.

Advantages that may be achieved is avoiding paging collision when a UE with more than one SIM-card is registered to more than one network at the same time. Generating the UE_offset in the CN makes sure that the paging messages for different UEs are evenly distributed. As the EPS cannot change the IMSI, using a UE_offset for both EPS and 5GS reduces complexity and improves readability of the specifications for both radio access technologies.

The method to avoid paging collision when a Multi-USIM UE is registered to more than one network at the same time begins with calculation of the PO. In the calculation of the PO, a UE_offset is selected by the CN and directly included in the PO formula as follows.

Option 1) PO calculation is modified

$$\begin{matrix}5 \text{G:} \left(\text{SFN} + \text{PF\_offset}\right) mod \text{T} = \\ \left(\text{T} \text{div} \text{N}\right) \text{*} \left(\left(\text{UE\_ID} + \text{UE\_offset}\right) mod \text{N}\right)\end{matrix}$$

$$\text{LTE:} \text{SFN} \text{mod} \text{T=} \left(\text{T} \text{div} \text{N}\right) \text{*} \left(\left(\text{UE\_ID} + \text{UE\_offset}\right) mod \text{N}\right)$$

where SFN is the system frame number, PF is the paging frame, T is the DRX cycle of the UE, N is the min(T, nB).

Optionally, the paging subframe can also be modified as follows:

$$\text{i\_s} = \text{floor} \left(\left(\text{UE\_ID} + \text{UE\_offset}\right) / \text{N}\right) mod \text{Ns}$$

Option 2) The PO formulas are not changed. Instead, the UE_IDis modified to change the resulting PO.

| | |
|---|---|
| UE_ID: (5G-S-TMSI + UE_offset) mod 1024 | (in the 5GS) |
| UE_ID: (IMSI + UE_offset) mod 1024 | (in the EPS) |

Using the same UE_offset value, both options would equally shift the original PO to avoid the PO collision.

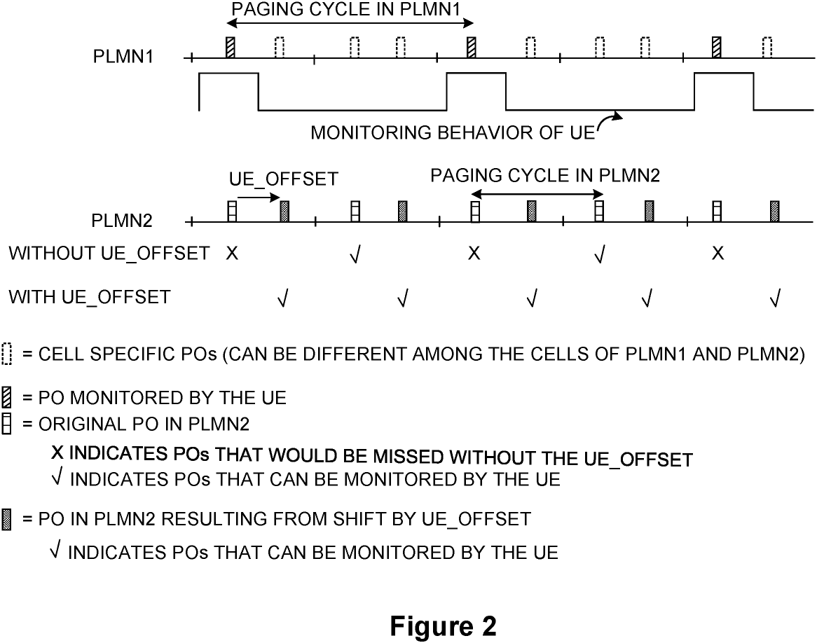

The UE_offset is initially set to the value 0 per default and it is updated by the CN as described above. FIG. 2 illustrates a shift of the PO by the UE_offset. ). It is noted that the monitoring behavior of the UE is for illustration purposes. It is up to UE implementation of when and how long to switch between PLMN1 and PLMN2 to monitor the POs of PLMN1 and PLMN2 respectively.

The core network has a good overview of the used IMSIs and UE _offsets and/or the allocated 5G-GUTIs and corresponding UE_offsets to find suitable UE_offsets that result in even distribution of paging messages. The CN would e.g. also avoid selecting UE_offsets that are multiples of N, where the possible values of N are known to the CN, to avoid that the same PO is calculated.

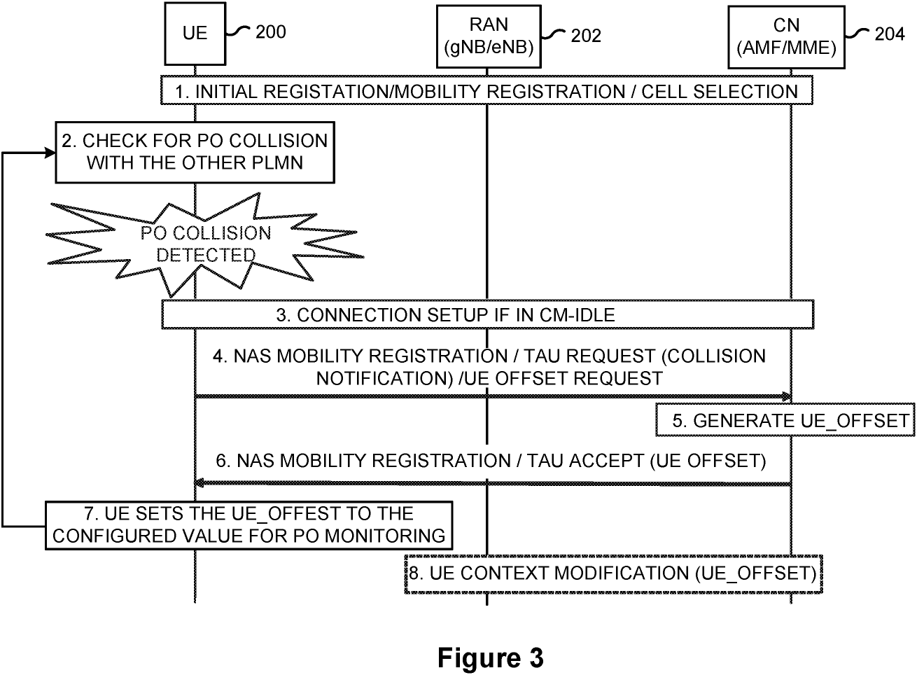

FIG. 3 illustrates an embodiment to avoid paging collision.

In operation 1, any one of the following actions which may be executed may result in a different PO:
The UE performs an Initial Registration to a PLMN where a new 5G-GUTI is assigned.
The UE (already registered in both PLMNs) performs a Mobility Registration on a PLMN and a new 5G-GUTI is assigned.
The UE (already registered in both PLMNs) executes a cell reselection in one of the PLMNs

In operation 2, the multi-USIM UE calculates the PO and checks for PO collisions with the other PLMN. If the PO collision is detected, blocks 3-7 (and, for 5GS networks, block 8) are executed.

In operation 3, if the multi-USIM UE is in RRC_IDLE or RRC _INACTIVE, the RRC connection is setup as per legacy. If the multi-USIM UE is in CM_IDLE, the connection to the CN is setup.

In operation 4, the multi-USIM UE notifies the core network via NAS signalling about the paging collision and requests a (new) UE_offset, e.g. via Mobility Registration or a TAU Request message

In operation 5, the core network generates a UE_offset for the UE.

In operation 6, the core network assigns the UE_offset to the UE via NAS signaling, e.g. via Mobility Registration or a TAU Accept Message.

In operation 7, the multi-USIM UE uses the new UE_offset value for PO monitoring and re-evaluates PO collision with the other PLMN.

In operation 8, for 5GS, the AMF executes the NGAP UE Context Modification procedure to inform the gNB about the configured UE_offset to be used by the gNB for RAN paging when the UE is in RRC_INACTIVE.

Operations 1-8 are repeated whenever the UE detects a possible Paging collision, e.g. the UE evaluates paging collision when any case in step 1 occurs, i.e. the evaluation is done at cell change and whenever a new 5G-GUTI is assigned to the UE.

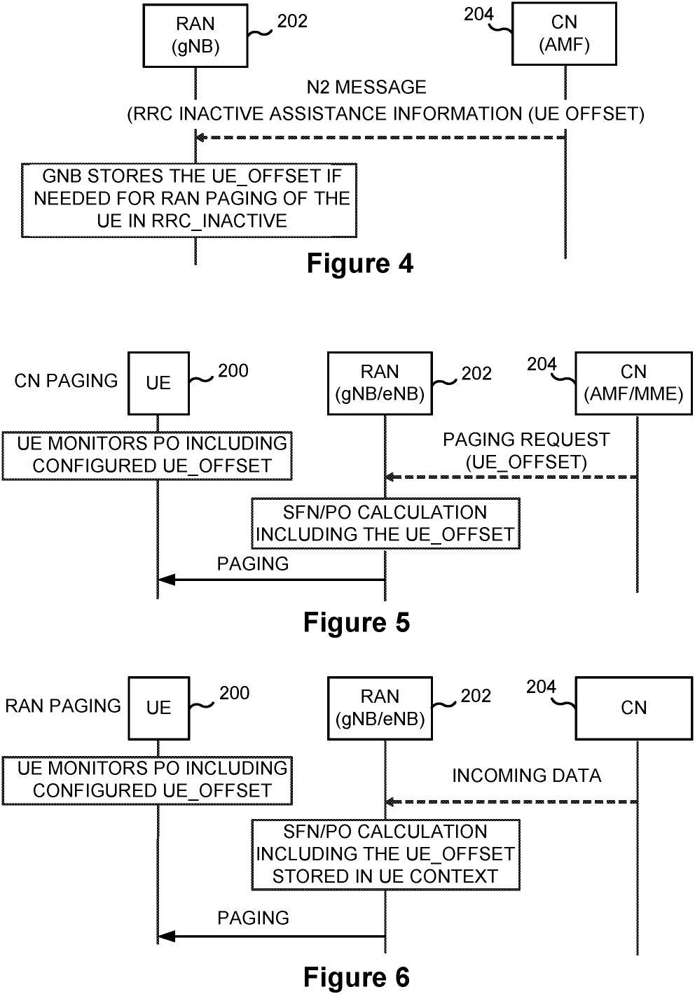

Note that in operation 8, which is applicable to 5GS only, the AMF executes step 8, the NGAP UE Context Modification procedure and provides the gNB with the UE_offset included in the RRC Inactive Assistance Information (see TS 23.501). The signalling flow and gNB action is shown in FIG. 4.

As a result, the paging procedures including the UE offset would include the core network providing the RAN node with the UE identify and the corresponding UE_offset as illustrated in FIG. 5.

When the UE needs to be paged by the RAN, the gNB uses the UE_offset that is stored as part of the UE context as illustrated in FIG. 6.

Thus, in case of a collision of paging occasion detected by the UE, the network generates a UE offset and assigns it to the UE resulting in a different/shifted paging occasion. Therefore, a paging collision can be avoided when a UE with more than one SIM-card is registered to more than one network at the same time. The CN has best knowledge about used IMSIs / 5G-S-IMSI and corresponding offsets to provide an optimal value for the UE_offset.

Thus, when a UE enters CM-IDLE or RRC inactive and MT traffic comes, in case of CM-IDLE, the CN (AMF/MME) triggers the Paging Request including the UE offset among other parameters. The RAN calculates the PF/PO based on UE offset and other parameters and triggers the paging.

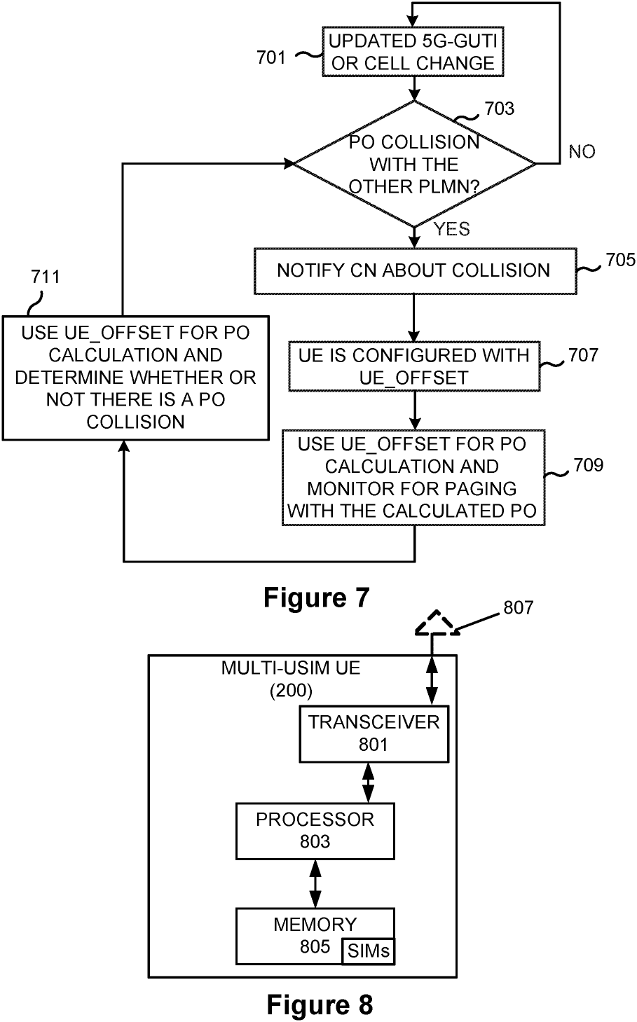

Operations of the multi-USIM UE 200 (implemented using the structure of the block diagram of FIG. 8) will now be discussed with reference to the flow chart of FIG. 7 according to some embodiments of inventive concepts. For example, modules may be stored in memory 805 of FIG. 8, and these modules may provide instructions so that when the instructions of a module are executed by respective multi-SIM UE processing circuitry 803, processing circuitry 803 performs respective operations of the flow chart.

Turning now to FIG. 7, a multi-universal subscriber identity module, multi-USIM user equipment, UE, operates in a first public land mobile network, PLMN, and another PLMN. The processing circuitry 803, responsive to at least one of receiving an updated 5G-global unique temporary identifier or changing a cell in which the multi-USIM UE is operating in block 701, determines in block 703 whether or not there is a paging occasion, PO, collision with the other PLMN.

Responsive to determining that there is a PO collision, the processing circuitry 703 notifies a core network about the PO collision. In some embodiments, the processing circuitry 703 also requests a “new” UE_offset. Notifying the core network about the PO collision comprises notifying the core network via non-access stratum, NAS, signaling about the PO collision.

In block 607, the processing circuitry 703 receives a configuration from the core network, the configuration having a UE_offset value. In block 609, the processing circuitry 703 uses the UE_offset value for PO calculations and monitoring.

In block 611, the processing circuitry 703 determines whether or not there is a PO collision with the other PLMN using the offset value. Determining whether or not there is a PO collision is some embodiments includes calculating a PO for the first PLMN with the UE_offset and comparing the PO for the first PLMN to the PO for the other PLMN.

In some embodiments, calculating the PO for the first PLMN comprises calculating the PO in accordance with

$$\begin{matrix}5 \text{G:} \left(\text{SFN} + \text{PF\_offset}\right) mod \text{T} = \\ \left(\text{T} \text{div} \text{N}\right) \text{*} \left(\left(\text{UE\_ID} + \text{UE\_offset}\right) mod \text{N}\right)\end{matrix}$$

$$\text{LTE:} \text{SFN} \text{mod} \text{T=} \left(\text{T} \text{div} \text{N}\right) \text{*} \left(\left(\text{UE\_ID} + \text{UE\_offset}\right) mod \text{N}\right)$$

where SFN is the system frame number, PF is the paging frame, T is the DRX cycle of the UE and N is min(T, nB)

In other embodiments, calculating the PO for the first PLMN comprises calculating the PO in accordance with

$$5 \text{G:} \left(\text{SFN} + \text{PF\_offset}\right) mod \text{T} = \left(\text{T} \text{div} \text{N}\right) \text{*} \left(\text{UE\_ID} mod \text{N}\right)$$

$$\text{LTE:} \text{SFN} \text{mod} \text{T=} \left(\text{T} \text{div} \text{N}\right) \text{*} \left(\text{UE\_ID} mod \text{N}\right)$$

| | |
|---|---|
| 5G UE_ID: (5G-S-TMSI + UE_offset) mod 1024 | (in the 5GS) |
| LTE UE_ID: (IMSI + UE_offset) mod 1024 | (in the EPS) |

where SFN is the system frame number, PF is the paging frame, T is the DRX cycle of the UE and N is min(T, nB), 5G-S-TMSI is a 5G Shortened Temporary Mobile Subscriber Identity, IMSI is an international mobile subscriber identity.

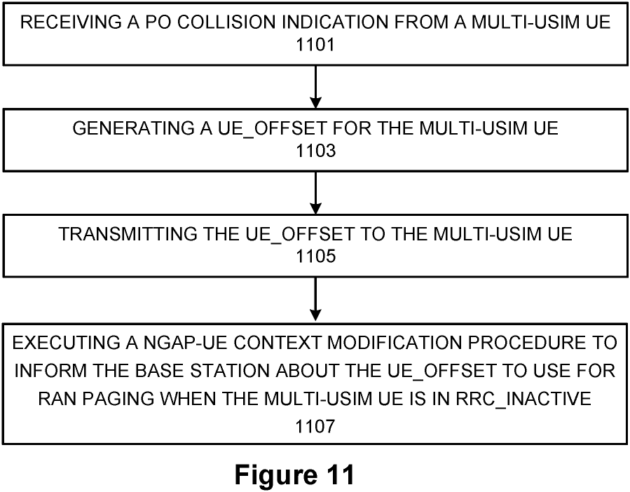

Operations of a Core Network CN node 204 (implemented using the structure of FIG. 10) will now be discussed with reference to the flow chart of FIG. 11 according to some embodiments of inventive concepts. For example, modules may be stored in memory 1005 of FIG. 10, and these modules may provide instructions so that when the instructions of a module are executed by respective CN node processing circuitry 1003, processing circuitry 1003 performs respective operations of the flow chart.

Turning now to FIG. 11, in block 1101, the processing circuitry 1003 receives a UE_offset request from a multi-universal subscriber identity module, multi-USIM, user equipment, UE, 200. In block 1103, the processing circuitry 1003 generates a new UE _offset.

In block 1105, the processing circuitry 1003 transmits the new UE_offset to the multi-USIM UE 200.

In block 1107, the processing circuitry 1003 executes a next generation application protocol, NGAP, UE Context Modification procedure to inform a base station about the new UE_offset to be used by the base station for radio access network, RAN, paging when the multi-USIM UE is in RRC _INACTIVE

Various operations from the flow chart of FIG. 11 may be optional with respect to some embodiments of CN nodes and related methods. Regarding methods of example embodiment 10 (set forth below), for example, operations of block 1107 of FIG. 11 may be optional.

Example embodiments are discussed below.

### EXAMPLE EMBODIMENTS

1. A method performed by a multi-subscriber identity module, multi-SIM user equipment, UE, operating in a first public land mobile network, PLMN, and another PLMN, the method comprising:
responsive to at least one of receiving an updated 5G-global unique temporary identifier or changing a cell in which the multi-SIM UE is operating (701), determining (703) whether or not there is a paging occasion (PO) collision with the other PLMN;
responsive to determining that there is a PO collision:
   notifying (705) a core network about the PO collision;
   receiving (707) a configuration from the core network, the configuration having a
UE_offset value;
using (709) the UE_offset value for PO calculation and monitoring; and
determining (711) whether or not there is a PO collision with the other PLMN using the UE _offset value.

2. The method of Embodiment 1 wherein notifying the core network about the PO collision comprises notifying the core network via non-access stratum, NAS, signaling about the PO collision.

3. The method of any of Embodiments 1-2 wherein determining whether or not there is a PO collision comprises calculating a PO for the first PLMN with the new UE _offset and comparing the PO for the first PLMN to the PO for the second PLMN.

4. The method of Embodiment 3 wherein calculating the PO for the first PLMN comprises calculating the PO in accordance with

$$\begin{matrix}5 \text{G:} \left(\text{SFN} + \text{PF\_offset}\right) mod \text{T} = \\ \left(\text{T} \text{div} \text{N}\right) \text{*} \left(\left(\text{UE\_ID} + \text{UE\_offset}\right) mod \text{N}\right)\end{matrix}$$

$$\text{LTE:} \text{SFN} \text{mod} \text{T=} \left(\text{T} \text{div} \text{N}\right) \text{*} \left(\left(\text{UE\_ID} + \text{UE\_offset}\right) mod \text{N}\right)$$

where SFN is the system frame number, PF is the paging frame, T is the DRX cycle of the UE and N is min(T, nB).

5. The method of Embodiment 3 wherein calculating the PO for the first PLMN comprises calculating the PO in accordance with

$$5 \text{G:} \left(\text{SFN} + \text{PF\_offset}\right) mod \text{T} = \left(\text{T} \text{div} \text{N}\right) \text{*} \left(\text{UE\_ID} mod \text{N}\right)$$

$$\text{LTE:} \text{SFN} \text{mod} \text{T=} \left(\text{T} \text{div} \text{N}\right) \text{*} \left(\text{UE\_ID} mod \text{N}\right)$$

| | |
|---|---|
| 5G UE_ID: (5G-S-TMSI + UE_offset) mod 1024 | (in the 5GS) |
| LTE UE_ID: (IMSI + UE_offset) mod 1024 | (in the EPS) |

where SFN is the system frame number, PF is the paging frame, T is the DRX cycle of the UE and N is min(T, nB), 5G-S-TMSI is a 5G Shortened Temporary Mobile Subscriber Identity, IMSI is an international mobile subscriber identity.

6. The method of Embodiment 3 wherein calculating the PO for the first PLMN comprises calculating the PO in accordance with

$$5 \text{G:} \left(\text{SFN} + \text{PF\_offset}\right) mod \text{T} = \left(\text{T} \text{div} \text{N}\right) \text{*} \left(\text{UE\_ID} mod \text{N}\right)$$

$$\text{LTE:} \text{SFN} \text{mod} \text{T=} \left(\text{T} \text{div} \text{N}\right) \text{*} \left(\text{UE\_ID} mod \text{N}\right)$$

$$\text{i\_s} = \text{floor} \left(\left(\text{UE\_ID} + \text{UE\_offset}\right) / \text{N}\right) mod \text{Ns}$$

where SFN is the system frame number, PF is the paging frame, T is the DRX cycle of the UE, N is the min(T, nB).

7. A multi-subscriber identity module, multi-SIM, user equipment, UE, (200) adapted to perform operations comprising:
responsive to at least one of receiving an updated 5G-global unique temporary identifier or changing a cell in which the multi-SIM UE is operating (701), determining (703) whether or not there is a paging occasion (PO) collision with the other PLMN;
responsive to determining that there is a PO collision:
   notifying (705) a core network about the PO collision;
   receiving (707) a configuration from the core network, the configuration having a UE_offset value;
   using (709) the UE_offset value for PO calculation and monitoring; and
   determining (711) whether or not there is a PO collision with the other PLMN using the UE_offset value.

8. The multi-SIM UE (200) of Embodiment 7 wherein the multi-SIM UE (200) is further adapted to perform operations according to any of Embodiments 2-6.

9. A multi-subscriber identity module, multi-SIM, user equipment, UE, (200) comprising:
processing circuitry (703); and
memory (705) coupled with the processing circuitry, wherein the memory includes instructions that when executed by the processing circuitry causes the communication device to perform operations comprising:
   responsive to at least one of receiving an updated 5G-global unique temporary identifier or changing a cell in which the multi-SIM UE is operating (701), determining (703) whether or not there is a paging occasion (PO) collision with the other PLMN;
   responsive to determining that there is a PO collision:
      notifying (705) a core network about the PO collision;
      receiving (707) a configuration from the core network, the configuration having a UE_offset value;
      using (709) the UE_offset value for PO calculation and monitoring; and
      determining (711) whether or not there is a PO collision with the other PLMN using the UE_offset value.

10. The multi-SIM UE of Embodiment 9 wherein in notifying the core network about the PO collision, the memory includes instructions that when executed by the processing circuitry causes the communication device to perform operations comprising notifying the core network via non-access stratum, NAS, signaling about the PO collision.

11. The multi-SIM UE of any of Embodiments 9-10 wherein in determining whether or not there is a PO collision, the memory includes instructions that when executed by the processing circuitry causes the communication device to perform operations comprising calculating a PO for the first PLMN with the new UE_offset and comparing the PO for the first PLMN to the PO for the second PLMN.

12. The multi-SIM UE of Embodiment 11 wherein in calculating the PO for the first PLMN, the memory includes instructions that when executed by the processing circuitry causes the communication device to perform operations comprising calculating the PO in accordance with

$$\begin{matrix}5 \text{G:} \left(\text{SFN} + \text{PF\_offset}\right) mod \text{T} = \\ \left(\text{T} \text{div} \text{N}\right) \text{*} \left(\left(\text{UE\_ID} + \text{UE\_offset}\right) mod \text{N}\right)\end{matrix}$$

$$\text{LTE:} \text{SFN} \text{mod} \text{T=} \left(\text{T} \text{div} \text{N}\right) \text{*} \left(\left(\text{UE\_ID} + \text{UE\_offset}\right) mod \text{N}\right)$$

where SFN is the system frame number, PF is the paging frame, T is the DRX cycle of the UE and N is min(T, nB).

13. The multi-SIM UE of Embodiment 11 wherein in calculating the PO for the first PLMN, the memory includes instructions that when executed by the processing circuitry causes the communication device to perform operations comprising calculating the PO in accordance with

$$5 \text{G:} \left(\text{SFN} + \text{PF\_offset}\right) mod \text{T} = \left(\text{T} \text{div} \text{N}\right) \text{*} \left(\text{UE\_ID} mod \text{N}\right)$$

$$\text{LTE:} \text{SFN} \text{mod} \text{T=} \left(\text{T} \text{div} \text{N}\right) \text{*} \left(\text{UE\_ID} mod \text{N}\right)$$

| | |
|---|---|
| 5G UE_ID: (5G-S-TMSI + UE_offset) mod 1024 | (in the 5GS) |
| LTE UE_ID: (IMSI + UE_offset) mod 1024 | (in the EPS) |

where SFN is the system frame number, PF is the paging frame, T is the DRX cycle of the UE and N is min(T, nB), 5G-S-TMSI is a 5G Shortened Temporary Mobile Subscriber Identity, IMSI is an international mobile subscriber identity.

14. The multi-SIM UE of Embodiment 11 wherein in calculating the PO for the first PLMN, the memory includes instructions that when executed by the processing circuitry causes the communication device to perform operations comprising calculating the PO in accordance with

$$5 \text{G:} \left(\text{SFN} + \text{PF\_offset}\right) mod \text{T} = \left(\text{T} \text{div} \text{N}\right) \text{*} \left(\text{UE\_ID} mod \text{N}\right)$$

$$\text{LTE:} \text{SFN} \text{mod} \text{T=} \left(\text{T} \text{div} \text{N}\right) \text{*} \left(\text{UE\_ID} mod \text{N}\right)$$

$$\text{i\_s} = \text{floor} \left(\left(\text{UE\_ID} + \text{UE\_offset}\right) / \text{N}\right) mod \text{Ns}$$

where SFN is the system frame number, PF is the paging frame, T is the DRX cycle of the UE, N is the min(T, nB).

15. A computer program comprising program code to be executed by processing circuitry (703) of a multi-subscriber identity module, multi-SIM, user equipment, UE, (200), whereby execution of the program code causes the multi-SIM UE (200) to perform operations according to any of embodiments 1-6.

16. A computer program product comprising a non-transitory storage medium including program code to be executed by processing circuitry (703) of a multi-subscriber identity module, multi-SIM, user equipment, UE, (200), whereby execution of the program code causes the multi-SIM UE (200) to perform operations according to any of embodiments 1-6.

17. A method performed by a core network node (204), the method comprising:
receiving (1101) a paging occasion, PO, collision indication from a multi-subscriber identity module, multi-SIM, user equipment, UE, (200);
generating (1103) a UE _offset; and
transmitting (1105) the UE_offset to the multi-SIM UE (200).

18. The method of Embodiment 17, further comprising:

executing (1107) a non-access stratum, NAS, UE Context Modification procedure to inform a base station about the new UE_offset to be used by the base station for radio access network, RAN, paging when the multi-SIM UE is in RRC_INACTIVE.

19. A core network, CN, node (204) adapted to perform operations comprising:
receiving (1101) a paging occasion, PO, collision indication from a multi-subscriber identity module, multi-SIM, user equipment, UE, (200);
generating (1103) a UE _offset; and
transmitting (1105) the UE_ offset to the multi-SIM UE (200).

20. The CN node (204) of Embodiment 19, wherein the CN node (204) is further adapted to perform operations comprising:

executing (1107) a non-access stratum, NAS, UE Context Modification procedure to inform a base station about the new UE_offset to be used by the base station for radio access network, RAN, paging when the multi-SIM UE is in RRC_INACTIVE

21. A core network, CN, node (204) comprising:
processing circuitry (1003); and
memory (1005) coupled with the processing circuitry, wherein the memory includes instructions that when executed by the processing circuitry causes the CN node to perform operations comprising:
   receiving (1101) a paging occasion, PO, collision indication from a multi-subscriber identity module, multi-SIM, user equipment, UE, (200);
   generating (1103) a UE _offset; and
   transmitting (1105) the UE_ offset to the multi-SIM UE (200).

22. The CN node (204) of Embodiment 21 wherein the memory includes further instructions that when executed by the processing circuitry causes the CN node to perform operations comprising:

executing (1107) a non-access stratum, NAS, UE Context Modification procedure to inform a base station about the new UE_offset to be used by the base station for radio access network, RAN, paging when the multi-SIM UE is in RRC_INACTIVE.

23. A computer program comprising program code to be executed by processing circuitry (1003) of a core network, CN, node (204), whereby execution of the program code causes the CN node (204) to perform operations according to any of Embodiments 17-18.

24. A computer program product comprising a non-transitory storage medium including program code to be executed by processing circuitry (1003) of a core network, CN, node (204), whereby execution of the program code causes the CN node (204) to perform operations according to any of embodiments 17-18.

Explanations are provided below for various abbreviations/acronyms used in the present disclosure.

| | |
|---|---|
| Abbreviation | Explanation |
| 5G-GUTI | 5G Global Unique Temporary Identifier |
| 5G-S-TMSI | 5G Shortened Temporary Mobile Subscriber Identity |
| 5GC | Fifth Generation Core network |
| AMF | Access and Mobility management Function |
| EPC | Evolved Packet Core |
| IMSI | International Mobile Subscriber Identity |
| PF | Paging Frame |
| PLMN | Public Land Mobile Network |
| PO | Paging Occasion |
| RX | Receiver |
| SIM | GSM Subscriber Identity Module |
| SNF | System Frame Number |
| TX | Transmitter |
| UE | User Equipment |
| USIM | Universal Subscriber Identity Module |

References are identified below.

1. 3GPP TS 36.304, V16.1.0(2020-07); Technical Specification Group Radio Access Network; Evolved Universal Terrestrial Radio Access (E-UTRA); User Equipment (UE) Procedures In Idle Mode (Release 16).

2. 3GPP TS 38.304, V16.1.0 (2020-07); Technical Specification Group Radio Access Network; NR; User Equipment (UE) Procedures In Idle Mode and RRC Inactive State (Release 16).

3. 3GPP TS 38.331, V16.1.0 (2020-07); Technical Specification Group Radio Access Network; NR; Radio Resource Control (RRC) Protocol Specification (Release 16).

4. 3GPP TS 38.413, V16.2.0 (2020-07); Technical Specification Group Radio Access Network; NG-RAN; NG-Application Protocol (NGAP) (Release 16).

5. 3GPP TR 23.761, V0.4.0 (2020-06); Technical Specification Group Services and System Aspects; Study On System Enablers For Devices Having Multiple Universal Subscriber Identity Modules (USIM) (Release 17).

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a multi-universal subscriber identity module, multi-USIM user equipment, UE, operating in a first public land mobile network, PLMN, and another PLMN, the method comprising:
responsive to at least one of receiving an updated 5G-global unique temporary identifier or changing a cell in which the multi-USIM UE is operating, determining whether or not there is a paging occasion (PO) collision with the other PLMN;
responsive to determining that there is a PO collision:
notifying a core network about the PO collision;
receiving a configuration from the core network, the configuration having a UE_offset value;
using the UE_offset value for PO calculation and monitoring; and
determining whether or not there is a PO collision with the other PLMN using the UE_offset value.

2. The method of claim 1 wherein notifying the core network about the PO collision comprises notifying the core network via non-access stratum, NAS, signaling about the PO collision.

3. The method of claim 1 wherein determining whether or not there is a PO collision comprises calculating a PO for the first PLMN with the new UE_offset and comparing the PO for the first PLMN to the PO for the second PLMN.

4. The method of claim 3 wherein calculating the PO for the first PLMN comprises calculating the PO in accordance with
$$\begin{matrix}5 \text{G:} \left(\text{SFN + PF\_offset}\right) mod \text{T} \text{=} \left(\text{T div N}\right) * \\ \left(\left(\text{UE\_ID} \text{+} \text{UE\_offset}\right) \text{mod N}\right)\end{matrix}$$
$$\begin{matrix}\text{LTE: SFN mod T} \text{=} \left(\text{T div N}\right) * \\ \left(\left(\text{UE\_ID} \text{+} \text{UE\_offset}\right) mod \text{N}\right)\end{matrix}$$
where SFN is the system frame number, PF is the paging frame, T is the DRX cycle of the UE and N is min(T, nB).

5. The method of claim 3 wherein calculating the PO for the first PLMN comprises calculating the PO in accordance with
$$\begin{matrix}5 \text{G:} \left(\text{SFN + PF\_offset}\right) mod \text{T} \text{=} \left(\text{T div N}\right) * \\ \left(\text{UE\_ID mod N}\right)\end{matrix}$$
$$\text{LTE: SNF} \text{} mod \text{T} \text{=} \left(\text{T div N}\right) * \left(\text{UE\_ID mod N}\right)$$
$$5 \text{G UE\_ID:} \left(5 \text{G-S-TMSI} \text{+} \text{UE\_offset}\right) \text{mod 1024} \left(\text{in the 5GS}\right)$$
$$\text{LTE UE\_ID:} \left(\text{IMSI} \text{+} \text{UE\_offset}\right) \text{mod 1024} \left(\text{in the EPS}\right)$$
where SFN is the system frame number, PF is the paging frame, T is the DRX cycle of the UE and N is min(T, nB), 5G-S-TMSI is a 5G Shortened Temporary Mobile Subscriber Identity, IMSI is an international mobile subscriber identity.

6. The method of claim 3 wherein calculating the PO for the first PLMN comprises calculating the PO in accordance with
$$5 \text{G:} \left(\text{SFN} \text{+} \text{PF\_offset}\right) \text{mod T =} \left(\text{T div N}\right) * \left(\text{UE\_ID mod N}\right)$$
$$\text{LTE: SFN mod T} \text{=} \left(\text{T div N}\right) * \left(\text{UE\_ID mod N}\right)$$
$$\text{i\_s} \text{=} \text{floor} \left(\left(\text{UE\_ID} \text{+} \text{UE\_offset}\right) / \text{N}\right) \text{mod Ns}$$
where SFN is the system frame number, PF is the paging frame, T is the DRX cycle of the UE, N is the min(T, nB).

7-8. (canceled)

9. A multi-universal subscriber identity module, multi-USIM, user equipment, UE, comprising:
processing circuitry; and
memory coupled with the processing circuitry, wherein the memory includes instructions that when executed by the processing circuitry causes the multi-USIM UE to perform operations comprising:
responsive to at least one of receiving an updated 5G-global unique temporary identifier or changing a cell in which the multi-USIM UE is operating, determining whether or not there is a paging occasion (PO) collision with the other PLMN;
responsive to determining that there is a PO collision:
notifying a core network about the PO collision;
receiving a configuration from the core network, the configuration having a UE_offset value;
using) the UE_offset value for PO calculation and monitoring; and
determining whether or not there is a PO collision with the other PLMN using the UE_offset value.

10. The multi-USIM UE of claim 9 wherein in notifying the core network about the PO collision, the memory includes instructions that when executed by the processing circuitry causes the communication device to perform operations comprising notifying the core network via non-access stratum, NAS, signaling about the PO collision.

11. The multi-USIM UE of claim 9 wherein in determining whether or not there is a PO collision, the memory includes instructions that when executed by the processing circuitry causes the communication device to perform operations comprising calculating a PO for the first PLMN with the new UE_offset and comparing the PO for the first PLMN to the PO for the second PLMN.

12. The multi-USIM UE of claim 11 wherein in calculating the PO for the first PLMN, the memory includes instructions that when executed by the processing circuitry causes the communication device to perform operations comprising calculating the PO in accordance with
$$5 \text{G:} \left(\text{SFN} \text{+} \text{PF\_offset}\right) mod \text{T} \text{=} \left(\text{T div N}\right) * \left(\left(\text{UE\_ID} \text{+} \text{UE\_offset}\right) mod \text{N}\right)$$
$$\text{LTE: SFN mod T=} \left(\text{T div N}\right) * \left(\left(\text{UE\_ID} \text{+} \text{UE\_offset}\right) mod \text{N}\right)$$
where SFN is the system frame number, PF is the paging frame, T is the DRX cycle of the UE and N is min(T, nB).

13. The multi-USIM UE of claim 11 wherein in calculating the PO for the first PLMN, the memory includes instructions that when executed by the processing circuitry causes the communication device to perform operations comprising calculating the PO in accordance with
$$5 \text{G:} \left(\text{SFN} \text{+} \text{PF\_offset}\right) mod \text{T} \text{=} \left(\text{T div N}\right) * \left(\text{UE\_ID mod N}\right)$$
$$\text{LTE: SFN mod T} \text{=} \left(\text{T div N}\right) * \left(\text{UE\_ID mod N}\right)$$
$$5 \text{G UE\_ID:} \left(5 \text{G-S-TMSI} \text{+} \text{UE\_offset}\right) mod 1024 \left(\text{in the 5GS}\right)$$
$$\text{LTE UE\_ID:} \left(\text{IMSI} \text{+} \text{UE\_offset}\right) mod 1024 \left(\text{in the EPS}\right)$$
where SFN is the system frame number, PF is the paging frame, T is the DRX cycle of the UE and N is min(T, nB), 5G-S-TMSI is a 5G Shortened Temporary Mobile Subscriber Identity, IMSI is an international mobile subscriber identity.

14. The multi-USIM UE of claim 11 wherein in calculating the PO for the first PLMN, the memory includes instructions that when executed by the processing circuitry causes the communication device to perform operations comprising calculating the PO in accordance with
$$5 \text{G:} \left(\text{SFN} \text{+} \text{PF\_offset}\right) mod \text{T} \text{=} \left(\text{T div N}\right) * \left(\text{UE\_ID mod N}\right)$$
$$\text{LTE: SFN mod T=} \left(\text{T div N}\right) * \left(\text{UE\_ID mod N}\right)$$
$$\text{i\_s} \text{=} \text{floor} \left(\left(\text{UE\_ID} \text{+} \text{UE\_offset}\right) / \text{N}\right) \text{mod Ns}$$
where SFN is the system frame number, PF is the paging frame, T is the DRX cycle of the UE, N is the min(T, nB).

15. (canceled)

16. A computer program product comprising a non-transitory storage medium including program code to be executed by processing circuitry of a multi-universal subscriber identity module, multi-USIM, user equipment, UE, whereby execution of the program code causes the multi-USIM UE to perform operations according to claim 1.

17. A method performed by a core network node, the method comprising:
receiving a paging occasion, PO, collision indication from a multi-universal subscriber identity module, multi-USIM, user equipment, UE;
generating a UE_offset; and
transmitting the UE_offset to the multi-USIM UE.

18. The method of claim 17, further comprising:
executing a next generation application protocol, NGAP, UE Context Modification procedure to inform a base station about the new UE_offset to be used by the base station for radio access network, RAN, paging when the multi-USIM UE is in RRC_INACTIVE.

19-20. (canceled)

21. A core network, CN, node comprising:
processing circuitry; and
memory coupled with the processing circuitry, wherein the memory includes instructions that when executed by the processing circuitry causes the CN node to perform operations comprising:
receiving a paging occasion, PO, collision indication from a multi- universal subscriber identity module, multi-USIM, user equipment, UE;
generating a UE_offset; and
transmitting the UE_offset to the multi-USIM UE.

22. The CN node of claim 21 wherein the memory includes further instructions that when executed by the processing circuitry causes the CN node to perform operations comprising:
executing a next generation application protocol, NGAP, UE Context Modification procedure to inform a base station about the new UE_offset to be used by the base station for radio access network, RAN, paging when the multi-USIM UE is in RRC_INACTIVE.

23. (canceled)

24. A computer program product comprising a non-transitory storage medium including program code to be executed by processing circuitry of a core network, CN, node, whereby execution of the program code causes the CN node to perform operations according to any of claim 17.
